(19) United States
(12) Patent Application Publication
(10) Pub. No.: US 2016/0088219 A1
(43) Pub. Date: Mar. 24, 2016

(54) IMAGE CAPTURE APPARATUS WHICH CONTROLS FRAME RATE BASED ON MOTION OF OBJECT, INFORMATION TRANSMISSION APPARATUS, IMAGE CAPTURE CONTROL METHOD, INFORMATION TRANSMISSION METHOD, AND RECORDING MEDIUM

(71) Applicant: CASIO COMPUTER CO., LTD., Tokyo (JP)

(72) Inventor: Naoya MATSUMOTO, Tokyo (JP)

(73) Assignee: CASIO COMPUTER CO., LTD., Tokyo (JP)

(21) Appl. No.: 14/857,667

(22) Filed: Sep. 17, 2015

(30) Foreign Application Priority Data
Sep. 22, 2014 (JP) 2014-193089
Jul. 17, 2015 (JP) 2015-143108

(51) Int. Cl. H04N 5/232; H04N 5/235; G06T 5/30; H04N 5/77

(52) U.S. Cl. CPC H04N 5/23219; H04N 5/772; H04N 5/2353; G06T 5/30; G06T 2207/10016

(57) ABSTRACT

An image capture apparatus 1 includes an image capture unit 16, a first communication unit 20, and an image capture control unit 53. The first communication unit 20 receives data indicating a movement of a predetermined object from a sensor which is attached to the object. The image capture control unit 53 controls a recording frame rate of a plurality of images captured by the image capture unit 16 based on the data received by the first communication unit 20. It is thereby possible with the image capture apparatus 1 to control so as to be a recording frame rate of an image corresponding to a movement of an object, since it is possible to perform image capture control based on data indicating a movement of the object thus received.

This application is based upon and claims the benefit of priority under 35 USC 119 of Japanese Patent Application No. 2014-193089 filed on Sep. 22 2014 and Japanese Patent Application No. 2015-143108 filed on Jul. 17 2015 the entire disclosure of which, including the description, claims, drawings, and abstract, is incorporated herein by reference in its entirety.

### BACKGROUND OF THE INVENTION

1. Field of the Invention

The present invention relates to an image capture apparatus which controls a frame rate based on a motion of an object, an information transmission apparatus, an image capture control method, an information transmission method, and a program.

2. Related Art

As disclosed in Japanese Unexamined Patent Application, Publication No. 2012-120151, for example, conventionally a technology has been known that specifies a position of an object as a desired photographic subject by calculating a motion vector in images that are sequentially captured, and raises the frame rate for recording if the position thus specified is located at a predetermined position within a display.

### SUMMARY OF THE INVENTION

An image capture apparatus includes: an image capture unit; a reception unit that receives data indicating a movement of a predetermined object from a sensor which is attached to the object; and a control unit that controls a recording frame rate of a plurality of images captured by the image capture unit based on the data received by the reception unit.

An information transmission apparatus includes: a sensor that is attached to a predetermined object; an acquisition unit that acquires data indicating a movement of the predetermined object by the sensor; and a transmission unit that externally transmits information of a recording frame rate based on the data indicating a movement of the predetermined object acquired by the acquisition unit.

An image capture control method executed by an image capture apparatus that includes an image capture unit includes the steps of: receiving data indicating a movement of a predetermined object from a sensor which is attached to the object; and controlling a recording frame rate of an image captured by the image capture unit based on the data received in the step of receiving.

An information transmission method for transmitting information of a recording frame rate includes the steps of: acquiring data indicating a movement of a predetermined object from a sensor which is attached to the object; and transmitting information of a recording frame rate externally based on data indicating the movement of the object acquired in the step of acquiring.

A non-transitory storage medium is encoded with a computer-readable program that enables a computer to execute functions as: a reception unit that receives data indicating a movement of a predetermined object from a sensor which is attached to the object; and a control unit that controls a recording frame rate of a plurality of images captured by the image capture unit based on the data received by the reception unit.

A non-transitory storage medium is encoded with a computer-readable program that enables a computer to execute functions as: an acquisition unit that acquires data indicating a movement of a predetermined object from a sensor which is attached to the object; and a transmission unit that transmits information of a recording frame rate externally based on data relating to the movement of the object acquired by the acquisition unit.

### BRIEF DESCRIPTION OF THE DRAWINGS

FIG. 1A is a schematic view illustrating a photography principle with an image capture apparatus according to an embodiment of the present invention;

FIG. 1B is a schematic view illustrating a photography principle with an image capture apparatus according to an embodiment of the present invention;

FIG. 2 is a block diagram showing the hardware configuration of an image capture apparatus according to an embodiment of the present invention;

FIG. 3 is a functional block diagram illustrating a functional configuration for executing photography processing among the functional configurations of the image capture apparatus of FIG. 2;

FIG. 4 is a schematic view for illustrating a calculation method of an evaluation value;

FIG. 5 is a flowchart illustrating a flow of photography processing executed by an image capture apparatus of FIG. 2 having the functional configuration of FIG. 3; and

FIG. 6 is a flowchart illustrating another flow of photography processing executed by an image capture apparatus of FIG. 2 having the functional configuration of FIG. 3.

### DETAILED DESCRIPTION OF THE INVENTION

Embodiments of the present invention are explained below with reference to the drawings.

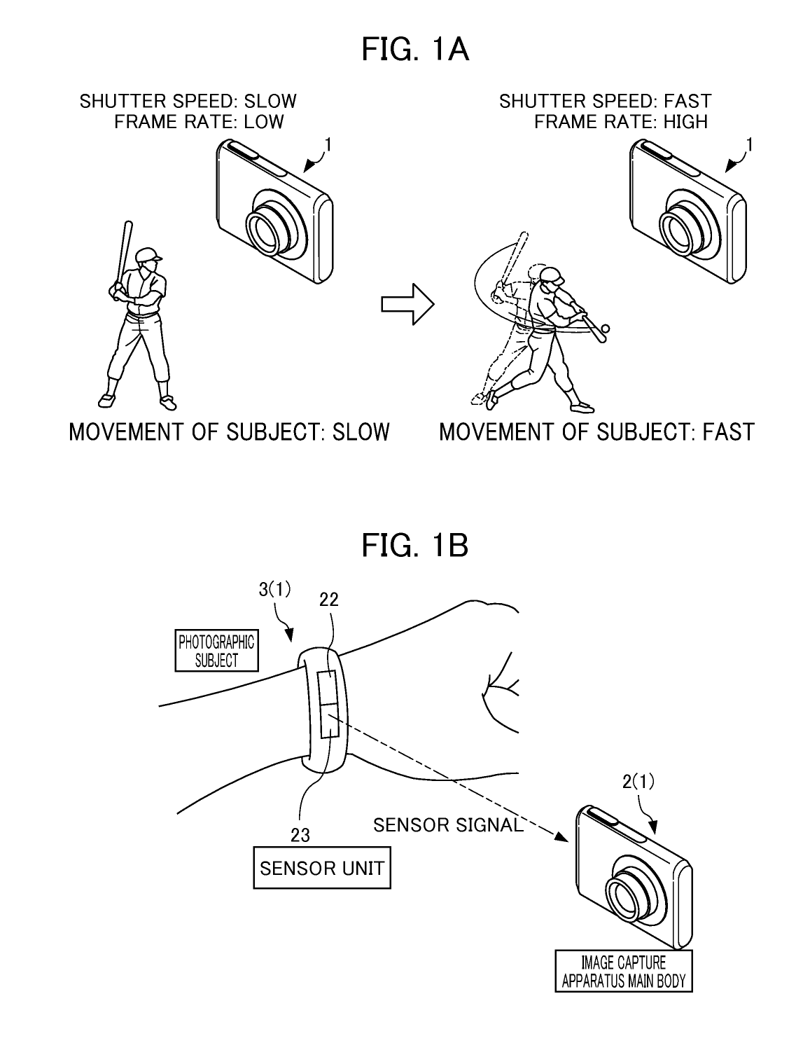

FIGS. 1A and 1B is a schematic view illustrating a photography principle with an image capture apparatus according to an embodiment of the present invention.

In the present embodiment, as illustrated in FIG. 1A, a static image is captured by changing the shutter speed or a moving image is photographed by changing the frame rate in accordance with a movement of an object as a photographic subject. More specifically, in a case of a movement of the object as a photographic subject being fast, a fast shutter speed is employed upon photographing a static image and a high frame rate is employed upon photographing a moving image. By performing such photography control, it is possible to photograph a static image without blur for the case of photographing a static image, and avoid a moving image in which the movement of the subject suddenly jumps for the case of photographing a moving image.

Furthermore, when a movement of an object as a photographic subject is slow, photography control is performed such that a slow shutter speed a shutter speed is changed as slow speed in the case of photographing a static image, and a frame rate is changed as a low rate in the case of photographing a moving image.

More specifically, for example, for a case of photographing a baseball batter as a photographic subject, in a condition of the subject holding the bat before starting a swing which is regarded as a movement of the photographic subject being static, i.e. slow, photography control is performed such that the shutter speed is changed as a slow speed in the case of photographing a static image, and the frame rate is changed as a low rate in the case of photographing a moving image (for example, 30 fps). On the other hand, with the fast motion of the subject as the photographic subject when in the middle of the swing, photographic control is performed such that the shutter speed is changed as a fast speed in the case of photographing a static image, and the frame rate is changed as a high rate in the case of photographing a moving image (e.g., 240 fps). Finally, in a condition of the subject finishing the swing which is regarded as a movement of the photographic subject being static, i.e. slow, photography control is performed such that the shutter speed is changed as a slow speed in the case of photographing a static image, and the frame rate is changed as a low rate in the case of photographing a moving image (for example, 30 fps).

As understood from the moving image photographed in this way, it possible to photograph consecutive images or a moving image which are photographed as slow motion during only a period of the batter swinging.

In the present embodiment, as illustrated in FIG. 1B, the movement of a photographic subject is judged based on sensor information outputted from a sensor unit 3 attached to an object as the photographic subject. In other words, the sensor information outputted from the sensor unit 3 is analyzed at the image capture apparatus main body 2, and then photography control is performed based on the analysis result.
Furthermore, in the present embodiment, simply analyzing whether there is a movement or the speed of the movement based on the sensor information is performed. Furthermore, the behavior of the subject is estimated from the sensor information, and subsequent photography control is performed based on an estimated behavior.

In the present embodiment, since photography control is performed based on a sensor attached to an object as a photographic subject, for example, it is possible to perform photography that reliably shoots the movement of the photographic subject, without being influenced by other moving objects, etc.

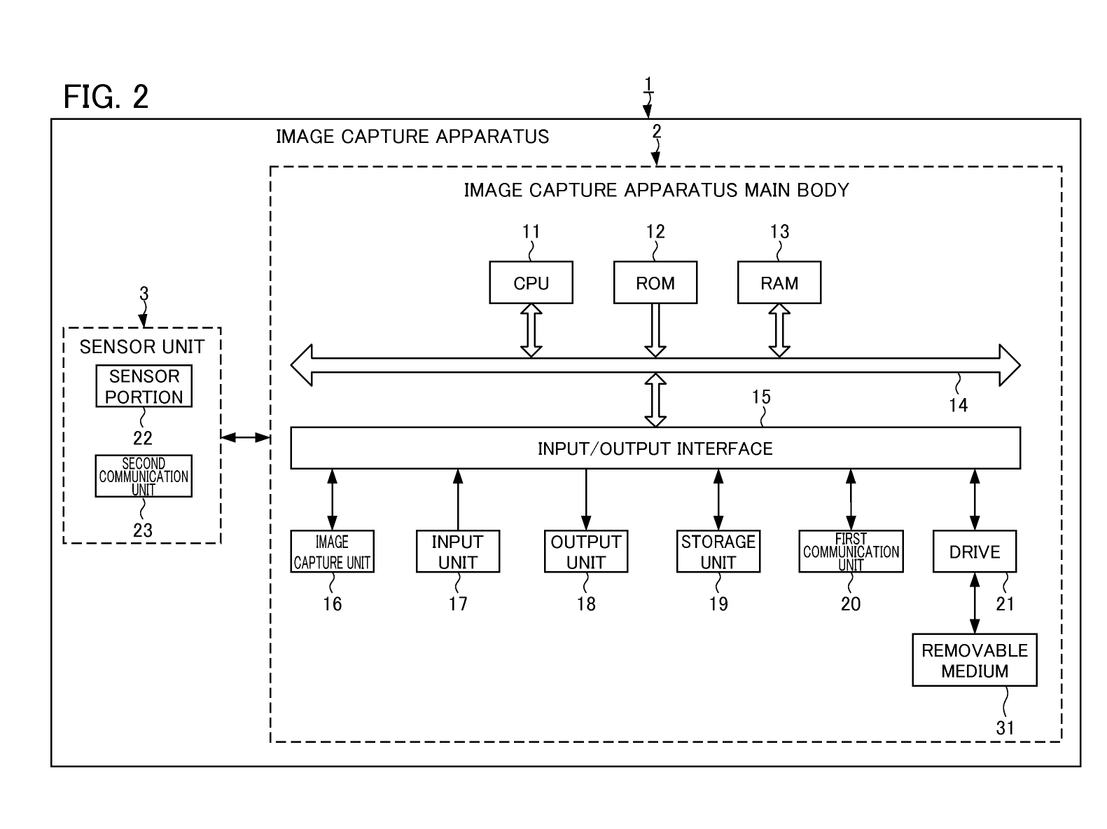

FIG. 2 is a block diagram showing the hardware configuration of an image capture apparatus according to an embodiment of the present invention.

The image capture apparatus 1 includes an image capture apparatus main body 2 and a sensor unit 3.

The image capture apparatus main body 2 is configured as a digital camera, for example.

The image capture apparatus main body 2 includes a CPU (Central Processing Unit) 11, ROM (Read Only Memory) 12, RAM (Random Access Memory) 13, a bus 14, an input/output interface 15, an image capture unit 16, an input unit 17, an output unit 18, a storage unit 19, a communication unit 20, and a drive 21.

The CPU 11 executes various processing according to programs that are recorded in the ROM 12, or programs that are loaded from the storage unit 19 to the RAM 13.

The RAM 13 also stores data and the like necessary for the CPU 11 to execute the various processing, as appropriate.

The CPU 11, the ROM 12 and the RAM 13 are connected to one another via the bus 14. The input/output interface 15 is also connected to the bus 14. The image capture unit 16, the input unit 17, the output unit 18, the storage unit 19, the first communication unit 20, and the drive 21 are connected to the input/output interface 15.

The image capture unit 16 includes an optical lens unit and an image sensor, which are not shown.

In order to photograph a subject, the optical lens unit is configured by a lens such as a focus lens and a zoom lens for condensing light.

The focus lens is a lens for forming an image of a subject on the light receiving surface of the image sensor. The zoom lens is a lens that causes the focal length to freely change in a certain range.

The optical lens unit also includes peripheral circuits to adjust setting parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device. The optoelectronic conversion device optoelectronically converts (i.e. captures) the image of the subject, accumulates the resultant image signal for a predetermined time interval, and sequentially supplies the image signal as an analog signal to the AFE.

The AFE executes a variety of signal processing such as A/D (Analog/Digital) conversion processing of the analog signal. The variety of signal processing generates a digital signal that is output as an output signal from the image capture unit 16.

Such an output signal of the image capture unit 16 is hereinafter referred to as “data of a captured image”. Data of a captured image is supplied to the CPU 11, an image processing unit (not illustrated), and the like as appropriate.

The input unit 17 is configured by various buttons and the like, and inputs a variety of information in accordance with instruction operations by the user.

The output unit 18 is configured by the display unit, a speaker, and the like, and outputs images and sound.

The storage unit 19 is configured by DRAM (Dynamic Random Access Memory) or the like, and stores data of various images.

The first communication unit 20 controls communication with other devices (not shown) via networks including the Internet. Furthermore, the first communication unit 20 is configured so as to make it possible to perform wireless communication with the sensor unit 3. More specifically, the first communication unit 20 performs communication with the sensor unit 3 via Bluetooth (Registered Trademark), which is a short-distance radio wave communication standard.

A removable medium 31 composed of a magnetic disk, an optical disk, a magneto-optical disk, semiconductor memory or the like is installed in the drive 21, as appropriate. Programs that are read via the drive 21 from the removable medium 31 are installed in the storage unit 19, as necessary. Similarly to the storage unit 19, the removable medium 31 can also store a variety of data such as the image data stored in the storage unit 19.

Furthermore, the sensor unit 3 is attached to an object which is a photographic subject to be able to detect a movement, and the sensor unit 3 includes a sensor portion 22 and a second communication unit 23.

Furthermore, since the sensor unit 3 assumes to be worn on a human as an object, the sensor unit 3 is configured in a bracelet shape which can be used by being worn on a wrist (arm) as illustrated in FIG. 1B. It should be noted that the sensor unit 3 may be configured in a collar shape or any shape that is attached to a collar in a case other than a human as an object, such as a cat or a dog. In other words, it is configured so as to able to select the most appropriate attachment means in accordance with a photographic subject for attachment.

The sensor portion 22 is configured with a gyro sensor that can detect a tri-axis acceleration of the XYZ axes and angular velocity. The sensor portion 22 outputs a signal indicating the acceleration thus detected (hereinafter, referred to as “sensor signal”) to the second communication unit 23.

The second communication unit 23 transmits the sensor signals that are sequentially outputted from the sensor portion 22 to the image capture apparatus main body 2.

The sensor signals detected by the sensor portion 22 from the sensor unit 3 are transmitted to the image capture apparatus 2, and at the image capture apparatus main body 2, an evaluation value relating to a movement of a photographic subject is calculated and the behavior of the photographic subject is estimated based on a current action of the photographic subject.

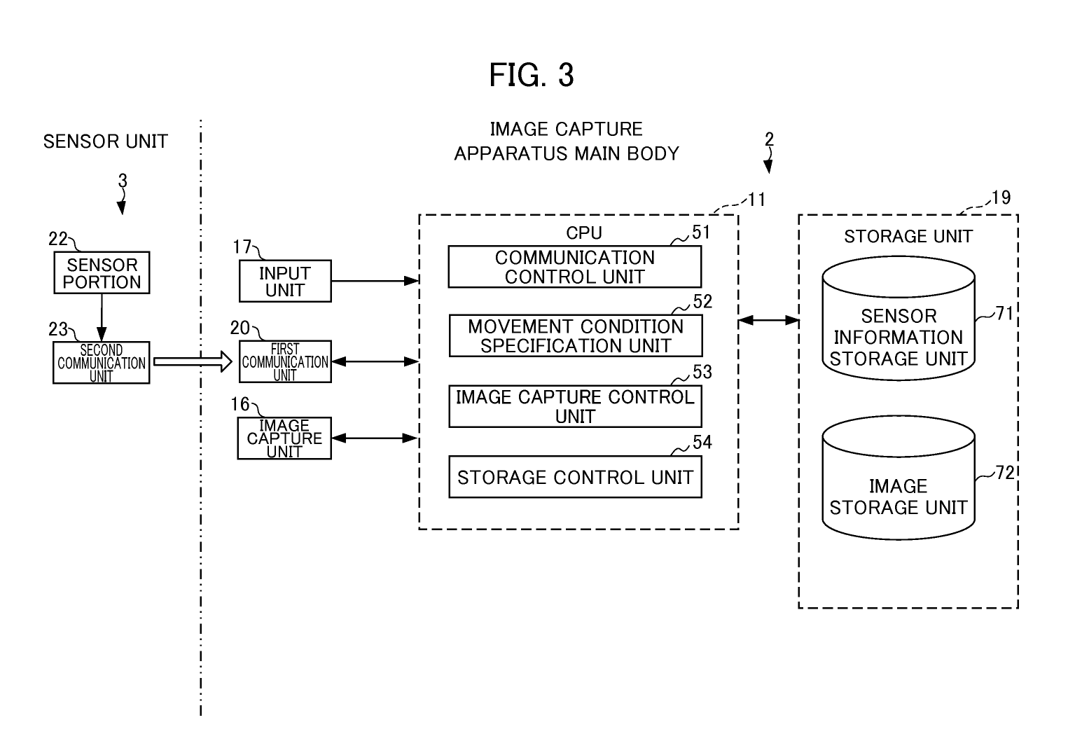

FIG. 3 is a functional block diagram illustrating a functional configuration for executing photography processing among the functional configurations of the image capture apparatus 1.

The photography processing refers to a sequence of processing of photographing a static image and a moving image from photography control based on a movement of a photographic subject detected.

As illustrated in FIG. 3, in a case of performing photography processing, a communication control unit 51, a movement condition specification unit 52, an image capture control unit 53, and a storage control unit 54 function in the CPU 11.

Furthermore, the sensor information storage unit 71 and the image storage unit 72 are established in a region of the storage unit 19.

Sensor information which is sensor signals outputted from the sensor portion 22 is stored in the sensor information storage unit 71.

Data of static images and moving images are stored in the image storage unit 72.

The communication control unit 51 controls the first communication unit 20 to receive the sensor signals transmitted from the second communication unit 23. The sensor signals thus received are stored in the sensor information storage unit 71 as sensor information.

The movement condition specification unit 52 estimates an intensity of a movement or a behavior based on the sensor information stored in the sensor information storage unit 71. Furthermore, the movement condition specification unit 52 specifies a movement condition of a photographic subject based on the estimated intensity of the movement or the estimated behavior.

In a case of estimating the intensity of a movement based on the sensor information stored in the sensor information storage unit 71, the movement condition specification unit 52 calculates a value to serve as an index of the intensity of a movement (hereinafter, referred to as “evaluation value”). The evaluation value can be calculated using the existing technology in Japanese Unexamined Patent Application, Publication No. 2008-245815, for example.

It should be noted that the evaluation value is calculated using the following method in the present embodiment.

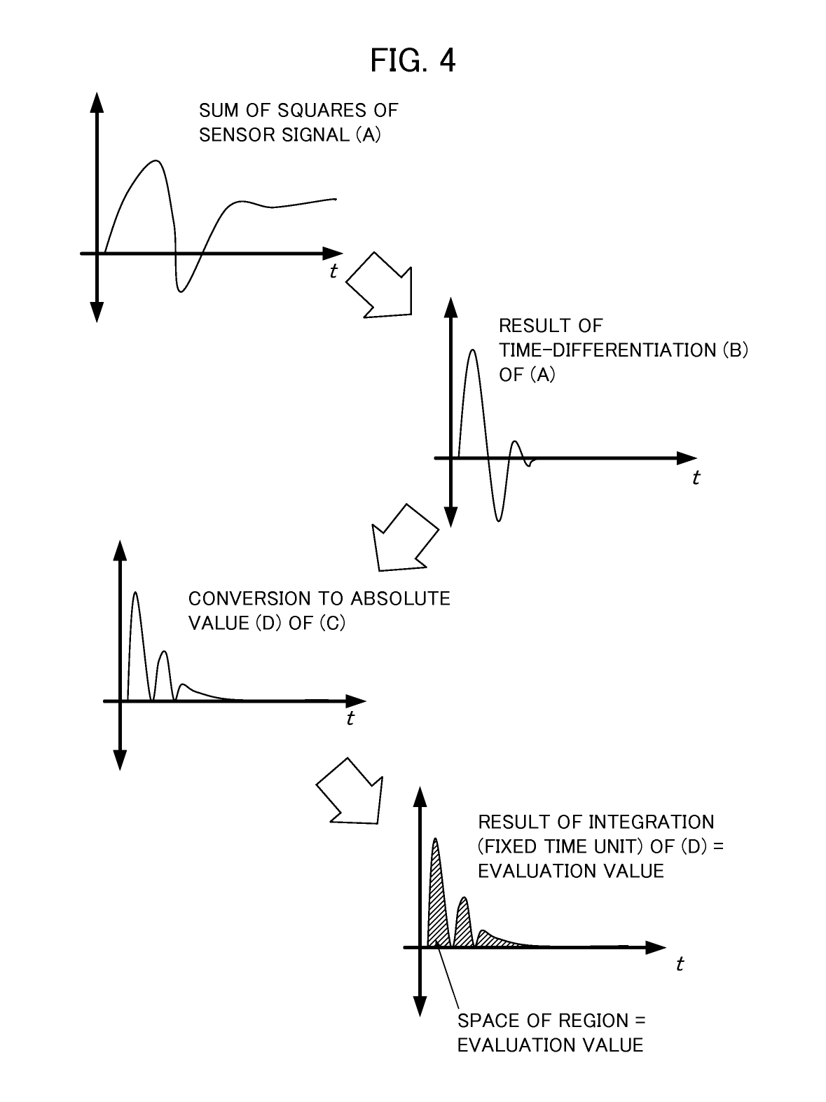

FIG. 4 is a schematic view for illustrating a calculation method of an evaluation value.

As illustrated in FIG. 4, for the evaluation value, the sum of squares of a sensor signal of a triaxial acceleration (A) is calculated. Next, the sum of squares of the sensor signal thus calculated (A) is differentiated to calculate differential values (B). The differential values (B) of the sum of squares of the sensor signal (A) are converted to an absolute value (D). The differential value (D) that is converted to the absolute value is integrated within a continuous time, and a portion corresponding to a space of a region thus integrated is set as an evaluation value.

As the evaluation value thus calculated is higher, the intensity of a movement is regarded as greater, which is reflected in subsequent photography control.

Furthermore, the evaluation value is also calculated during photographing, and if a fluctuation occurs in the evaluation value, it is reflected in the photography control.

Furthermore, the movement condition specification unit 52 can calculate using various existing technologies that take into account a change, periodicity, etc. of a sensor signal corresponding to a specific action, for example, in a case of estimating a behavior such as batting, based on the sensor information stored in the sensor information storage unit 71. For example, it is possible to estimate a behavior by performing matching with a movement model that is made by collecting data for each behavior in advance from the relationship of acceleration and angular velocity for each axis of XYZ with the periodicity in the sensor signals.

The image capture control unit 53 captures a static image with a shutter speed corresponding to a movement condition specified from the intensity of an estimated action or the estimated behavior, and controls the image capture unit 16 to photograph a moving image with a frame rate corresponding to a movement condition specified from the intensity of an estimated action or the estimated behavior.

More specifically, in a case of a movement condition of a photographic subject in which the evaluation value is high or a behavior during swinging is estimated, for example, the image capture control unit 53 controls the image capture unit 16 to photograph a static image with a fast shutter speed. Furthermore, in a case of a movement condition of a photographic subject in which the evaluation value is low or a behavior of holding a bat is estimated, for example, the image capture control unit 53 controls the image capture unit 16 to photograph a static image with a slow shutter speed.

In a case of a movement condition of a photographic subject in which the evaluation value is high or a behavior during swinging is estimated, for example, the image capture control unit 53 controls the image capture unit 16 to photograph a moving image with a high frame rate. Furthermore, in a case of a movement condition of a photographic subject in which the evaluation value is low or a behavior of holding a bat is estimated, for example, the image capture control unit 53 controls the image capture unit 16 to photograph a moving image with a low frame rate.

The storage control unit 54 causes the image storage unit 72 to store data of static images and moving images outputted from the image capture unit 16.

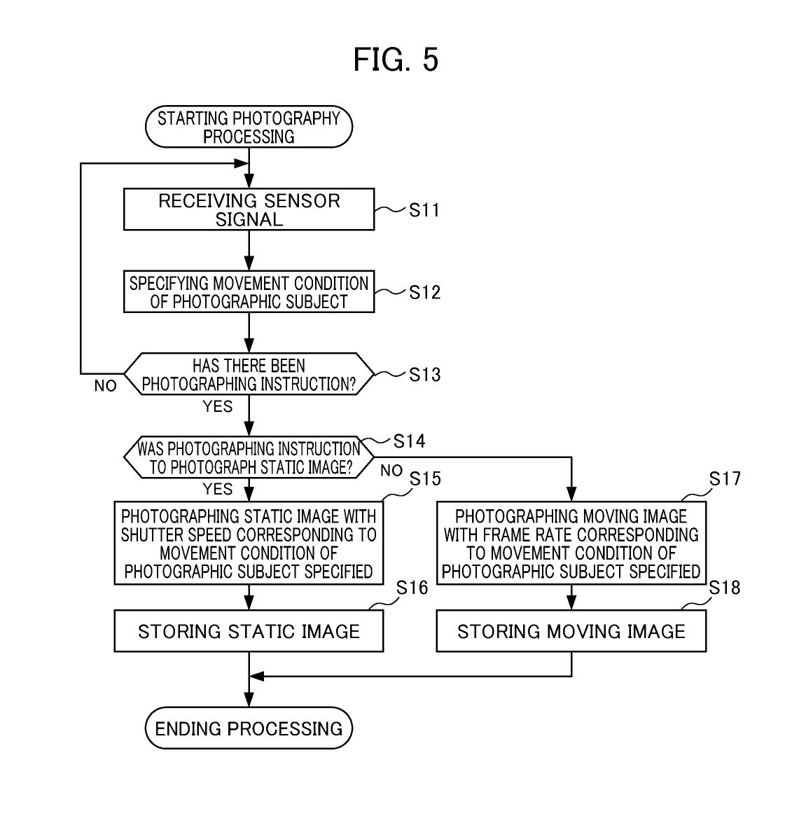

FIG. 5 is a flowchart illustrating a flow of photography processing executed by the image capture apparatus 1 of FIG. 2 having the functional configuration of FIG. 3.

The photography processing starts with an operation of starting photography processing on the input unit 17 by a user.

In Step S11, the communication control unit 51 controls the first communication unit 20 so as to receive sensor signals that are sequentially transmitted from the second communication unit 23.

In Step S12, the movement condition specification unit 52 specifies a movement condition of a photographic subject based on an intensity of a movement estimated or an estimated behavior, based on sensor signals that are sensor information stored in the sensor information storage unit 71.

More specifically, the movement condition specification unit 52 calculates an evaluation value in a case of estimating the intensity of a movement. As illustrated in FIG. 4, for the evaluation value, first, the sum of squares of a sensor signal of a triaxial acceleration (A) is calculated. Next, the sum of squares of the sensor signal thus calculated (A) is differentiated to calculate differential values (B). The differential values (B) of the sum of squares of the sensor signal (A) are converted to an absolute value (D). The differential value (D) that is converted to the absolute value is integrated within a continuous time, and a portion corresponding to a space of a region thus integrated is set as an evaluation value.

Furthermore, in a case of estimating a behavior, the movement condition specification unit 52 estimates the behavior by performing matching with a movement model that is made by collecting data for each action in advance from the relationship of acceleration and angular velocity of each axis of XYZ with the periodicity in the sensor signals. As a result, the behavior of batting is estimated, for example.

In Step S13, the image capture control unit 53 judges whether there has been a photographing instruction by the user via the input unit 17.

In a case in which there has not been a photographing instruction, it is judged as NO in Step S13, and the processing returns to Step S11.

In a case in which there has been a photographing instruction, it is judged as YES in Step S13, and the processing advances to Step S14.

In Step S14, the image capture control unit 53 judges whether the photographing instruction by the user via the input unit 17 was to photograph a static image.

In a case in which the photographing instruction is not to photograph a static image, but rather a moving image, it is judged as NO in Step S14, and the processing advances to Step S17. The processing after Step S17 is described later.

In a case in which the photographing instruction is to photograph a static image, it is judged as YES in Step S14, and the processing advances to Step S15.

In Step S15, the image capture control unit 53 controls the image capture unit 16 so as to photograph a static image with a shutter speed corresponding to a movement condition specified. More specifically, in a case of a movement condition of a photographic subject in which the evaluation value is high or a behavior during swinging is estimated, for example, the image capture control unit 53 controls the image capture unit 16 to photograph a static image with a fast shutter speed. Furthermore, in a case of a movement condition of a photographic subject in which the evaluation value is low or a behavior of holding a bat is estimated, for example, the image capture control unit 53 controls the image capture unit 16 to photograph a static image with a slow shutter speed.

In Step S16, the storage control unit 54 causes the image storage unit 72 to store data of the static image outputted from the image capture unit 16.

In Step S17, the image capture control unit 53 controls the image capture unit 16 so as to photograph a moving image with a frame rate corresponding to a movement condition specified. More specifically, in a case of a movement condition of a photographic subject in which the evaluation value is high or a behavior during swinging is estimated, for example, the image capture control unit 53 controls the image capture unit 16 to photograph a moving image with a high frame rate. Furthermore, in a case of a movement condition of a photographic subject in which the evaluation value is low or a behavior of holding a bat is estimated, for example, the image capture control unit 53 controls the image capture unit 16 to photograph a moving image with a low frame rate.

In Step S18, the storage control unit 54 causes the image storage unit 72 to store data of a moving image outputted from the image capture unit 16.

Furthermore, although it is configured so as to specify a movement condition of a photographic subject before instructing to photograph for the purpose of reducing processing load, etc., at the time of the photography processing in the abovementioned photography processing, the present invention is not limited thereto, and it may also be configured so as to specify a movement condition of a photographic subject after instructing to photograph in consideration of a real-time property.

In other words, although it is configured so as to photograph a moving image/static image with a frame rate/shutter speed according to a movement condition specified before the operation of pressing the shutter (before photographing), it may also be configured so as to photograph a moving image/static image with a frame rate/shutter speed based on a real-time movement condition at the time of photographing according to the movement condition specified from sensor information acquired at the time of the operation of pressing the shutter (at the time of photographing).

In this case, it is more preferable to reflect the movement condition at the time of the photography processing, and thus it may also be configured so as to acquire sensor information at a predetermined timing based on a condition of being able to photograph, and to specify the movement condition based on sensor information which is the closest to the timing of photographing.

Furthermore, for example, it may also be configured so as to predict a movement condition which is subsequently predicted based on a specified movement condition of changing, for example, from a preparatory action for a main action at the time of photographing (for example, a condition of preparing to swing) to the main action after a predetermined lapse of time (for example, a condition of swinging), and set the predicted movement condition as a movement condition at the time of photographing.

Furthermore, in the abovementioned photography processing, it may also be configured so as to specify a movement condition of a photographic subject before photographing and specify again a movement condition of a photographic subject after photographing for the purpose of confirmation. With such a configuration, it is possible to improve a specific accuracy and reliability.

Furthermore, although it is configured to photograph a moving image/static image with the frame rate/shutter speed determined before photographing being fixed in one-time photographing in the abovementioned photography processing, it may also be configured, for example, so as to perform photographing with the frame rate/shutter speed being fixed in a case of photographing performed within a predetermined time during the start to the end of a sequence of a movement condition.

Furthermore, it may also be configured so as to perform processing of specifying a movement condition of a photographic subject upon a preparatory operation for instructing to photograph (for example, performing power-on, setting a mode, half-pressing the shutter, etc.) being performed, in the abovementioned photography processing.

### MODIFIED EXAMPLE

Although it is configured to photograph a moving image/static mage with the frame rate/shutter speed determined before photographing being fixed in the abovementioned embodiment, it may also be configured so as to specify a movement condition during photographing a moving image or a plurality of static images and change a frame rate/shutter speed according to the movement condition thus specified and perform subsequent moving image/static image photographing. In other words, it is configured so as to photograph a moving image/static image by changing the frame rate/shutter speed so as to be variable even during photography.

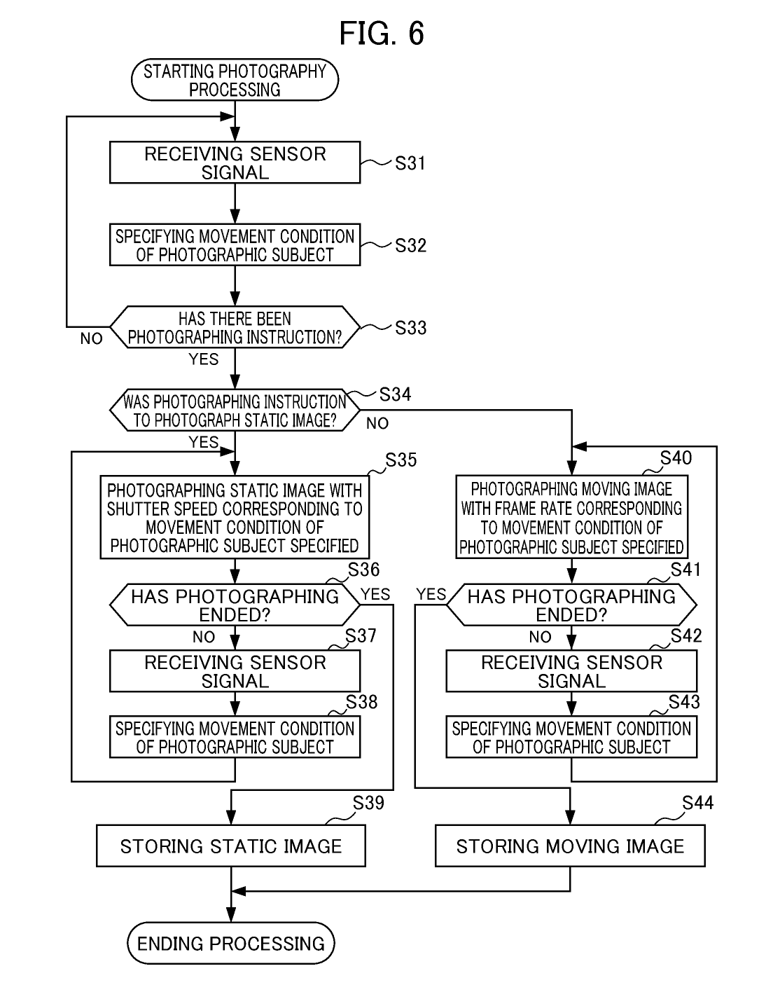

FIG. 6 is a flowchart illustrating another flow of photography processing executed by the image capture apparatus 1 of FIG. 2 having the functional configuration of FIG. 3. It should be noted that descriptions for steps similar to those in the flow of the photography processing illustrated in FIG. 5 will be omitted.

In Step S36, the image capture control unit 53 judges whether photographing has ended, for example, based on whether a predetermined number of photographs has arrived or whether an operation of ending photographing was performed.

In a case of the photographing having ended, it is judged as YES in Step S36, and the processing advances to Step S39.

On the other hand, in a case of the photographing not having ended, it is judged as NO in Step S36, and the processing advances to Step S37.

In Step S37, the communication control unit 51 controls the first communication unit 20 so as to receive sensor signals that are sequentially transmitted from the second communication unit 23.

In Step S38, the movement condition specification unit 52 estimates an intensity of a movement or a behavior based on the sensor signals which are sensor information stored in the sensor information storage unit 71, and specifies a movement condition of a photographic subject based on the estimated intensity of the movement or the estimated behavior.

Then, in Step S35 again, the image capture control unit 53 controls the image capture unit 16 so as to photograph a static image with a shutter speed according to a movement condition newly specified in Step S38.

In Step S41, the image capture control unit 53 determines whether the photographing has ended based on, for example, whether a predetermined photographing time has elapsed or an operation of ending photographing was performed.

In a case of the photographing having ended, it is judged as YES in Step S41, and the processing advances to Step S44.

On the other hand, in a case of the photographing not having ended, it is judged as NO in Step S41, and the processing advances to Step S42.

In Step S42, the communication control unit 51 controls the first communication unit 20 so as to receive sensor signals that are sequentially transmitted from the second communication unit 23.

In Step S43, the movement condition specification unit 52 estimates an intensity of a movement or a behavior based on the sensor signals which are sensor information stored in the sensor information storage unit 71, and specifies a movement condition of a photographic subject based on the estimated intensity of the movement or the estimated behavior.

Then, in Step S40 again, the image capture control unit 53 controls the image capture unit 16 so as to photograph a static image with a frame rate according to a movement condition newly specified in Step S43.

Therefore, in the image capture apparatus 1, it is possible to photograph a static image without blur for the case of a static mage and avoid a moving image in which the movement of the subject suddenly jumps for the case of a moving image. Furthermore, in the image capture apparatus 1, since photography control is performed based on a sensor attached to a photographic subject, for example, it is possible to perform photography that reliably shoots the movement of the photographic subject, without being influenced by other moving objects, etc.

The image capture apparatus 1 configured as described above includes the image capture unit 16, the first communication unit 20, and the image capture control unit 53.

The first communication unit 20 receives data indicating a movement of the object by a sensor attached to a predetermined object.

The image capture control unit 53 controls a recording frame rate of a plurality of images captured by the image capture unit 16 based on the data received by the first communication unit 20.

It is thereby possible with the image capture apparatus 1 to control so as to be a recording frame rate of an image corresponding to a movement of an object, since image capture control can be performed based on data indicating the movement of the object received.

The image capture apparatus 1 further includes the movement condition specification unit 52 that acquires a condition of a movement of an object based on data indicating a movement of an object received by the first communication unit 20.

The image capture control unit 53 controls a recording frame rate based on the condition of the movement of the object.

It is thereby possible with the image capture apparatus 1 to perform control of the recording frame rate that is suited for the condition of the movement of the object thus acquired.

The movement condition specification unit 52 estimates a behavior of an object from data indicating the movement of the object, based on the timing of the photography processing by the image capture unit 16.

It is thereby possible with the image capture apparatus 1 to estimate a behavior of the object according to the timing of the photography processing from the image capture unit 16, and perform control of a recording frame rate which is better suited to the condition of the movement of the object thus acquired.

The CPU 11 obtains time information.

The movement condition specification unit 52 estimates a preparatory action to a behavior of a predetermined object as the behavior of the object based on data indicating the movement of the object, and the image capture control unit 53 controls a recording frame rate based on the preparatory action and a change in the time information obtained by the CPU 11 (by predicting a behavior of the object at a subsequent point of time). In other words, the movement condition specification unit 52 estimates a preparatory action relating to the behavior of the object based on data indicating the movement of the object.

The image capture control unit 53 controls the recording frame rate based on a movement which becomes a subsequent target for photographing that is predicted based on the preparatory action estimated by the movement condition specification unit 52.

More specifically, for example, it can be configured so that, upon storing a sequence of actions composed of a plurality of actions with each action to be associated with required times for actions, and recording frame rates thereof, control is performed so as to photograph with the recording frame rate according to each action by considering the elapsed time from the time of the movement estimated at the moment of starting image capturing.

Since it is thereby possible with the image capture apparatus 1 to perform photography by predicting a condition of a movement of an object at the time of photographing based on a preparatory action acquired in advance, it is possible to perform control of a recording frame rate that is better suited for the movement of the object thus acquired.

The movement condition specification unit 52 estimates a behavior of an object from data indicating the movement of the object.

Furthermore, the movement condition specification unit 52 specifies a behavior of an object based on the movement of the object thus estimated.

It is thereby possible with the image capture apparatus 1 to specify a movement of an object more accurately and perform control of a recording frame rate that is suited for only the object.

The image capture control unit 53 controls a shutter speed of the image capture unit 16 corresponding to a movement of an object.

It is thereby possible with the image capture apparatus 1 to photograph a static image of the object thus photographed without blur.

The image capture control unit 53 controls a recording frame rate by changing an image capture frame rate corresponding to a movement of an object.

It is thereby possible with the image capture apparatus 1 to acquire a moving image in which a movement does not suddenly jump.

The sensor portion 22 is a gyro sensor.

It is thereby possible with the image capture apparatus 1 to specify a movement of an object more accurately, and perform control of a recording frame rate that is adapted for only a photographic subject.

The sensor unit 3 includes an antenna member, which is the second communication unit 23 that receives data indicating a movement of the object from the sensor portion 22.

It is thereby possible with the image capture apparatus 1 to specify a more accurate movement of an object with a simple configuration.

The image capture control unit 53 controls a recording frame rate so as to be a recording frame rate with an acquisition interval based on the movement of an object received by the second communication unit 23. In other words, the image capture control unit 53 controls a recording frame rate so as to be a recording frame rate with an acquisition interval that corresponds to a condition of a movement of a photographic subject.

It is thereby possible with the image capture apparatus 1 to specify a movement of an object more accurately and perform control of a recording frame rate that is better suited for only a photographic subject.

The movement condition specification unit 52 estimates a movement of an object based on data indicating a movement of an object at least at any timing among a time before the image capturing processing, at the same time, and a time subsequent to the image capturing processing.

It is thereby possible with the image capture apparatus 1 to perform control of a recording frame rate which is better suited for only a photographic subject at various timings, in consideration of processing load of photography, accuracy improvement for a condition of a movement of an object which is closer to the time of photographing.

Furthermore, the second communication unit 23 includes an antenna member that transmits, externally from a wireless method, the data received by the first communication unit 20 as information relating to a recording frame rate.

It is thereby possible with the image capture apparatus 1 to specify a more accurate action of an object with a simple configuration and control a recording frame rate.

It should be noted that the present invention is not to be limited to the aforementioned first and second embodiments, and that modifications, improvements, etc. within a scope that can achieve the objects of the present invention are also included in the present invention.

In the abovementioned embodiment, it is configured so as to raise the frame rate itself in the image capture unit 16. However, the method of controlling the frame rate may also be configured such that a moving image is stored so as to be a desired frame rate by thinning out frame images from a moving image captured with a predetermined frame rate by the image capture unit 16.

More specifically, the image capture apparatus 1 further includes a storage control unit 54 that controls processing of storing a plurality of consecutive images in the image storage unit 72.

In a case of photographing the plurality of consecutive images, the storage control unit 54 thins out frame images constituting a moving image from a moving image photographed so as to be a recording frame rate of the plurality of consecutive images corresponding to a movement of a photographic subject, so as to change the final recording frame rate of the plurality of consecutive images, and controls processing of storing the plurality of consecutive images in the image storage unit 72.

Furthermore, it may also be configured so that a moving image with a predetermined frame rate is stored, and the moving image is edited so as to be a desired frame rate upon outputting.

Furthermore, in the abovementioned embodiment, for example, in a case of performing photographing with a high frame rate (for example, 100 fps) and performing the acquisition of frame images at a predetermined interval (for example, an interval with five frames skipped) so as to be a desired frame rate (for example, 30 fps) at the time of acquiring the frame image (generally, acquiring frame images in a thinned-out condition), when performing photography control on a moving image with a high frame rate as a result of having specified a movement condition of a subject, it may be configured to adjust an interval of acquiring frame images to raise the frame rate. In other words, it may be configured so as to always perform photographing with a high frame rate, and adjust the final frame rate of a moving image with an interval of acquisition of frame images corresponding to a specifying result of a movement condition of a photographic subject.

More specifically, it may be configured so that the image capture control unit 53 changes the acquisition interval of frame images outputted from the image capture unit 16 so as to be a final recording frame rate of a moving image corresponding to a movement of a photographic subject.

Furthermore, in the abovementioned embodiment, it is configured that photography control is sequentially performed to reflect the result of specifying the movement condition of a photographic subject. However, it may also be configured so that, in a case in which a time lag occurs before reflecting the specifying result of the movement condition of the photographic subject in the photography control, buffering of the data outputted from the image capture unit 16 is performed in preparation for switching of the photography control, so as to compensate for a time lag portion with the buffered data.

Furthermore, although the sensor portion 22 is configured by a gyro sensor in the abovementioned embodiment, it may also be configured by a sensor such as an acceleration sensor which only detects acceleration. In such a case, more preferable photography control can be performed so long as a most appropriate sensor and action judgment algorithm are used depending on the purpose.

Furthermore, although it is configured to perform estimation of the movement of a photographic subject or estimation of the behavior based on sensor information from the sensor unit 3 attached to a photographic subject in the abovementioned embodiment, it may also be configured, for example, to analyze a live view image, estimate an intensity of a movement or a behavior of a photographic subject, and specify a movement condition of the photographic subject.

Furthermore, in the abovementioned embodiment, it may also be configured so as to store table data in which a movement condition of a photographic subject determined by estimating an intensity of a movement or a behavior of the photographic subject is associated with a shutter speed/frame rate, and perform photography control with reference to the table data.

Furthermore, although an example in which a sensor is attached to a human photographic subject is described in the abovementioned embodiment, it may also be configured so as to attach sensors to a plurality of photographic subjects. In such a case, in a case of a movement suddenly becoming quick or slow, i.e. in a case of there being a change from its current photography control, it may be configured to perform the photography control based on actions of all of the photographic subjects or based on a movement of any one among the photographic subjects.

Furthermore, although it is configured to perform the photography control based on a current movement condition of a photographic subject specified by estimating an intensity of a movement or performing estimation of a behavior in the abovementioned embodiment, it may also be configured so as to, for example, estimate a condition of a preparatory action to be performed from then and perform control at the time of photographing to correspond to a movement predicted from a condition of the preparatory action. More specifically, in a case of photographing a batter while swinging a bat, it can be configured to specify a movement of holding a bat as a preparatory action, and to perform control at the time of photographing by assuming a swing thereafter.

Furthermore, in the abovementioned embodiment, it is possible to set the number of consecutive images at the time of continuously photographing according to a movement of a photographic subject. It is also possible to control the frame rate by setting the number of consecutive images at the time of continuously photographing according to a movement of a photographic subject. For example, in a case of a photographic subject moving fast, blurring occurs due to its movement or an important scene comes in a moment. Therefore, it is necessary to increase the shutter speed by adjusting the number of consecutive images or the frame rate. At this time, it may be configured so as to store images before and after an operation of pressing a shutter button according to a photographic subject moving fast.

Furthermore, in the abovementioned embodiment, it is configured so as to control the frame rate by specifying a movement condition of a photographic subject at the side of the image capture apparatus main body 2. However, it may also be configured, after specifying a movement condition of a photographic subject at the side of the sensor unit 3, so as to instruct the side of the image capture apparatus main body 2 to perform photography processing with a frame rate corresponding to the movement condition thus specified. In other words, the sensor unit 3 may be configured so as to read information of a frame rate corresponding to the movement condition specified by the sensor unit 3 and transmit the information to the image capture apparatus main body 2, by performing the specification processing of the movement condition of the photographic subject in Step S12 of FIG. 5 at the side of the sensor unit 3, and storing in advance information of a plurality of frame rates corresponding to each of a plurality of movement conditions in the sensor unit 3. With such a configuration, it is possible for the image capture apparatus main body 2 to perform the photographing processing with a frame rate preferable to a movement condition by simply receiving a frame rate corresponding to a movement condition of a photographic subject from the sensor unit 3.

Furthermore, a system may be configured that performs the specification processing of a movement condition of a photographic subject in Step S12 of FIG. 5 at the side of the sensor unit 3, transmits the movement condition of the photographic subject specified by the specification processing to the image capture apparatus main body 2, and performs, by the image capture apparatus main body 2, the photography processing with a frame rate corresponding to the movement condition of the photographic subject. By configuring such a system, it is possible to reduce the processing load of the image capture apparatus main body 2.

Furthermore, it may also be configured so as to perform the photography control using sensor information or information of a movement condition of a photographic subject acquired in an external apparatus other than the image capture apparatus 1. Furthermore, it may also be configured so as to perform a judgment relating to the photography control in the sensor unit 3 or an external apparatus, transmit only an instruction for the photography control to the image capture apparatus main body 2, and perform the photography control based on the instruction at the side of the image capture apparatus main body 2.

Furthermore, in the abovementioned embodiment, although the sensor portion 22 is configured so as to be arranged at a position so as to acquire a movement of an arm, it may also be configured so as to arrange the sensor portion 22 at a portion so as to identify a movement that is desired to be acquired or it may also be configured so as to arrange a plurality of sensors.

It is possible to estimate in detail various kinds of preparatory movements such as a preparatory movement for a swing and a preparatory movement for a crouching start as movement conditions based on acceleration information, for example, by arranging the sensor portion 22 to be worn all over the body or the arms and legs.

Furthermore, in the abovementioned embodiment, although it is configured so as to change the frame rate in the two stages of high/low according to sensor information, it may also be configured to adjust the frame rate so as to be changed linearly without a step-wise limitation according to speed information of a photographic subject so as to perform more preferable photography.

Furthermore, in the abovementioned embodiment, although it is configured to estimate an intensity of a movement and a behavior based on information from the sensor unit 3, and specify a movement condition of a photographic subject based on the intensity of the estimated action and the behavior in the image capture apparatus main body 2, it may be configured so as to perform estimation/specification in the sensor unit 3. In such a case, it may be configured so as to transmit information (sensing information, estimated/specified information) at a predetermined interval in the sensor unit 3; however, it may also be configured so as to perform sensing at the sensor portion 22 based on information relating to image capturing from the image capture apparatus main body 2 and then transmit information (sensing information and estimated/specified information). For example, it may be configured so as to, in the image capture apparatus main body 2, in a case in which the photography processing is started by a preparatory movement of photography (a half-press shutter operation), a photographing operation (a full-pressing of shutter), or a full-press shutter operation being performed, perform sensing at the sensor portion 22 and transmit information (sensing information and estimated/specified information).

More specifically, the sensor portion 22 acquires data indicating a movement of an object with at least any timing among a time before the image capturing processing, at the same time, and a time subsequent to the image capturing processing.

It is thereby possible with the image capture apparatus 1 to perform control of a recording frame rate which is better suited for only a photographic subject with various kinds of timings in consideration of processing load due to focus of processing of photographing, accuracy improvement for a condition of a movement of an object which is closer to the time of photographing, etc.

Furthermore, it is possible to perform estimation/specification at the side of the sensor unit 3 for the purpose of reducing processing load, etc., on the image capture main body 2.

Furthermore, although it is configured to change a frame rate and/or shutter speed based on an estimated/specified result of a behavioral condition of a photographic subject in the abovementioned embodiment, the present invention is not limited thereto.

It is also acceptable to change/adjust elements for setting a photographic subject to be the most preferable photographed condition in a behavioral condition of the photographic condition at the time of photographing.

Furthermore, it can be configured so as to change/adjust elements so that a display condition becomes preferable from image processing based on an estimated/specified result of a behavioral condition of the photographic subject after photographing.

In the aforementioned embodiments, explanations are provided with the example of the image capture apparatus 1 to which the present invention is applied being a wearable terminal; however, the present invention is not limited thereto in particular.

For example, the present invention can be applied to any electronic device in general having a wireless communication function. More specifically, for example, the present invention can be applied to a laptop personal computer, a printer, a television receiver, a video camera, a portable navigation device, a cell phone device, a smartphone, a portable gaming device, and the like.

The processing sequence described above can be executed by hardware, and can also be executed by software.

In other words, the hardware configuration of FIG. 3 is merely illustrative examples, and the present invention is not particularly limited thereto. More specifically, the types of functional blocks employed to realize the above-described functions are not particularly limited to the examples shown in FIG. 3, so long as the image capture apparatus 1 can be provided with the functions enabling the aforementioned processing sequence to be executed in its entirety.

A single functional block may be configured by a single piece of hardware, a single installation of software, or a combination thereof.

In a case in which the processing sequence is executed by software, the program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium 31 of FIG. 2 distributed separately from the device main body for supplying the program to a user, but also can be constituted by a storage medium or the like supplied to the user in a condition incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray (Registered Trademark) or the like. The magnetic optical disk is composed of an MD (Mini-Disk) or the like. The storage medium supplied to the user in a condition incorporated in the device main body in advance is constituted by, for example, ROM 12 of FIG. 2 in which the program is recorded or a hard disk, etc. included in the storage unit 19 of FIG. 2.

It should be noted that, in the present specification, the steps defining the program recorded in the storage medium include not only the processing executed in a time series following this order, but also processing executed in parallel or individually, which is not necessarily executed in a time series.

The embodiments of the present invention described above are only illustrative, and are not to limit the technical scope of the present invention. The present invention can assume various other embodiments. Additionally, it is possible to make various modifications thereto such as omissions or replacements within a scope not departing from the spirit of the present invention. These embodiments or modifications thereof are within the scope and the spirit of the invention described in the present specification, and within the scope of the invention recited in the claims and equivalents thereof.

What is claimed is:

1. An image capture apparatus comprising:
an image capture unit;
a reception unit that receives data indicating a movement of a predetermined object from a sensor which is attached to the object; and
a control unit that controls a recording frame rate of a plurality of images captured by the image capture unit based on the data received by the reception unit.

2. The image capture apparatus according to claim 1, further comprising:
a first acquisition unit that acquires a condition of the movement of the object based on the data indicating the movement of the object received by the reception unit,
wherein the control unit controls the recording frame rate based on the condition of the movement of the object.

3. The image capture apparatus according to claim 1, further comprising:
an estimation unit that estimates a behavior of the object from the data indicating the movement of the object,
wherein the control unit controls the recording frame rate based on the behavior of the object which is estimated by the estimation unit.

4. The image capture apparatus according to claim 3,
wherein the estimation unit estimates the behavior of the object from data indicating the movement of the object, based on a timing of image capture processing by the image capture unit.

5. The image capture apparatus according to claim 3,
wherein the estimation unit estimates a preparatory movement relating to the behavior of the object from data indicating the movement of the object, and
wherein the control unit controls the recording frame rate based on a movement which becomes a subsequent target for photographing that is predicted from the preparatory movement.

6. The image capture apparatus according to claim 1, further comprising:
a storage control unit that controls processing of storing a plurality of consecutive images in a storage unit,
wherein, in a case of the image capture unit that captures a plurality of consecutive images, the storage control unit thins out frame images from the plurality of consecutive images so as to be a recording frame rate corresponding to the data indicating the movement of the object, so as to change a recording frame rate of a plurality of consecutive images, and controls processing of storing the plurality of consecutive images in the storage unit.

7. The image capture apparatus according to claim 1,
wherein the image capture unit captures a moving image,
wherein the control unit controls an acquisition interval of frame images outputted from the image capture unit so as to be a recording frame rate of the moving image corresponding to the data indicating the movement of the object.

8. The image capture apparatus according to claim 1,
wherein the control unit controls a shutter speed of the image capture unit according to the movement of the object.

9. The image capture apparatus according to claim 1,
wherein the control unit controls an image capture frame rate according to the movement of the object.

10. The image capture apparatus according to claim 1,
wherein the sensor is an acceleration sensor or a gyro sensor.

11. The image capture apparatus according to claim 1,
wherein the reception unit includes an antenna member that receives the data indicating the movement of the object by the sensor.

12. An information transmission apparatus comprising:
a sensor that is attached to a predetermined object;
an acquisition unit that acquires data indicating a movement of the predetermined object by the sensor; and
a transmission unit that externally transmits information of a recording frame rate based on the data indicating the movement of the predetermined object acquired by the acquisition unit.

13. The information transmission apparatus according to claim 12, further comprising:
a specification unit that specifies a condition of the movement of the object from the data indicating the movement of the object acquired by the acquisition unit,
wherein the transmission unit transmits information of the recording frame rate corresponding to the condition of the movement of the object specified by the specification unit.

14. The information transmission apparatus according to claim 13, further comprising:
an estimation unit that estimates a behavior of the object from the data indicating the movement of the object acquired by the acquisition unit,
wherein the acquisition unit acquires information of the movement of the object based on the behavior of the object estimated by the estimation unit.

15. The information transmission apparatus according to claim 12,
wherein the acquisition unit acquires the data indicating the movement of the object with at least any timing among a time before image capturing processing, at the same time, and a time subsequent to the image capturing processing.

16. An image capture control method executed by an image capture apparatus that includes an image capture unit, the method comprising the steps of:
receiving data indicating a movement of a predetermined object from a sensor which is attached to the object; and
controlling a recording frame rate of a plurality of images captured by the image capture unit based on the data received in the step of receiving.

17. An image capture control method executed by an image capture apparatus that includes an image capture unit, the method comprising the steps of:
receiving data indicating a movement of a predetermined object from a sensor which is attached to the object; and
controlling a shutter speed of the image capture unit based on the data received in the step of receiving.

18. An information transmission method for transmitting information of a recording frame rate, the method comprising the steps of:
acquiring data indicating a movement of a predetermined object from a sensor which is attached to the object; and
transmitting information of a recording frame rate externally based on data indicating the movement of the object acquired in the step of acquiring.

19. A non-transitory storage medium encoded with a computer-readable program that enables a computer to execute functions as:
a reception unit that receives data indicating a movement of a predetermined object from a sensor which is attached to the object; and
a control unit that controls a recording frame rate of a plurality of images captured by the image capture unit based on the data received by the reception unit.

20. A non-transitory storage medium encoded with a computer-readable program that enables a computer to execute functions as:
an acquisition unit that acquires data indicating a movement of a predetermined object from a sensor which is attached to the object; and
a transmission unit that transmits information of a recording frame rate externally based on data relating to the movement of the object acquired by the acquisition unit.
